(19) United States
(12) Patent Application Publication
(10) Pub. No.: US 2007/0009292 A1
(43) Pub. Date: Jan. 11, 2007

(54) Fusing unit and fusing apparatus of image forming apparatus using the fusing unit

(75) Inventors: Jeonghwa Kim, Suwon-si (KR); Hwan-guem Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/474,286

(22) Filed: Jun. 26, 2006

(30) Foreign Application Priority Data
Jun. 28, 2005 (KR) 10-2005-0056229

(51) Int. Cl. G03G 15/20

(52) U.S. Cl. 399/333

(57) ABSTRACT

A fusing unit and a fusing apparatus using the fusing unit and an image forming apparatus having the fusing apparatus are provided. The fusing unit includes a pipe-shaped fusing roller provided with a pipe-shaped internal pipe surrounded by a heating unit generating heat, a plurality of end caps disposed at both ends of the fusing roller, and a locking assembly for fastening the end caps to respective ends of the fusing roller, wherein the locking assembly has a first locking member fastened on an inner side surface of the fusing roller and a second locking member fastening one end of the fusing roller.

### CROSS-REFERENCE TO RELATED PATENT APPLICATION

This application claims the benefit of Korean Patent Application No. 10-2005-0056229, filed on Jun. 28, 2005, in the Korean Intellectual Property Office, the disclosure of which is incorporated by reference in its entirety.

### BACKGROUND OF THE INVENTION

1. Field of the invention

The present invention relates to a fusing unit and a fusing apparatus using the fusing unit and a image forming apparatus having the fusing apparatus. More particularly, the invention is directed to a fusing unit having a fastening assembly for fastening end caps to both ends of the fusing unit. The invention is also directed to a fusing apparatus using the fusing unit and an image forming apparatus having the fusing apparatus.

2. Description of Related Art

In general, a color image forming apparatus using an electrophotography scheme refers to an apparatus for forming a color image by irradiating light on a photosensitive medium charged with a predetermined electric potential to form an electrostatic latent image, developing the electrostatic latent image with predetermined color toners, and transferring and fusing the developed image onto a print medium.

Therefore, the image forming apparatus includes a fusing apparatus for applying heat and pressure to the toner image in order to fuse the toner image developed with the predetermined color toners onto the print medium.

FIG. 1 is a transverse cross sectional view schematically showing a fusing unit of a conventional fusing apparatus where a halogen lamp is used as a heat source. FIG. 2 is a longitudinal cross sectional view showing a relation between the fusing unit and a pressing roller shown in FIG. 1.

Referring to FIG. 1, a fusing unit 10 is a unit applying heat to a toner image and includes a pipe-shaped cylindrical fusing roller 11 and a heat generating unit 12 generating heat by using electrical current transmitted from an external power supply (not shown) provided to an inner side of the fusing roller 11. A release layer 11a made of an elastic material so as to improve releasability to the toner image is provided on a circumferential surface of the heat generating unit.

Radiation energy (heat) generated by the heat generating unit 11 is transmitted to the fusing roller 11 through air charged in an inner portion of the fusing roller 11 and converted to thermal energy by an opto-thermal conversion layer (not shown) coated on an inner side surface of the fusing roller 11 to heat the fusing roller 11. Then, the release layer 11a is heated up to a predetermined fusing temperature by thermal conduction.

Referring to FIG. 2, a pressing roller 13 facing the fusing unit 10 through a print medium 14 is disposed under the fusing unit 10. The pressing roller 13 is elastically-supported by a spring member 13a so as to press the print medium 14 passing between the fusing unit 10 and the pressing roller 13 toward the fusing unit 10.

At this time, the powder-state toner image 14a formed on the print medium 14 is pressed and heated with predetermined pressure and heat while the print medium 14 passes between the fusing unit 10 and the pressing roller 13. Namely, the toner image 14a is fused on the print medium 14 with predetermined temperature heat and pressure by the fusing unit 10 and the pressing roller 13.

In the conventional fusing apparatus using the aforementioned halogen lamp as a heat source, since a large amount of electric power is unnecessarily consumed, a temperature thereof must be lowered by blocking the electric power in a printing standby mode, and a relatively long warm-up time is required after the fusing apparatus is turned on for a printing task until the fusing apparatus reaches a fusing temperature. A predetermined time taken after the fusing apparatus is turned on until the fusing apparatus reaches a desired fusing temperature is called a first-print-out-time (hereinafter, referred to as FPOT). In some cases, the FPOT of the fusing apparatus using the aforementioned halogen lamp as a heat source may be tens of seconds or several minutes.

In particular, since the fusing roller of the conventional fusing apparatus is heated by the radiation energy transmitted from the heat source, the heat transmission rate is slow. Since the heat is transmitted to the print medium by the contact of the fusing roller to the print medium, the compensation for temperature variation is slow due to a decrease in temperature, so that it is difficult to control the temperature distribution.

In order to overcome this problem, fusing roller apparatuses using a heat pipe having a high thermal conductivity to facilitate instantaneous heating and a characteristic of low power consumption are disclosed in Japanese Patent Application Nos. Heisei 5-135656 and Heisei 10-84137.

The fusing roller apparatus using such a heat pipe has a structure where heat source having different shapes are arranged to side end portions of a fusing roller, which are not in a fusing region. According to the arrangement of the heat sources, since the whole size of the fusing roller apparatus may greatly increase, there has been a need to simplify the complicated structure.

In addition, fusing roller apparatuses disposed in Japanese Patent Application Nos. Sowha 58-163836, Heisei 3-107438, Heisei 3-136478, Heisei 6-316435, and Heisei 7-65878 have a heat source provided in an inner portion of a fusing roller. Therefore, although the whole size of the fusing roller apparatus does not greatly increase, since the fusing roller apparatus has a structure where a plurality of localized heat pipes are provided to the fusing roller, there is a shortcoming in that fabrication and production thereof is very complicated. In addition, since the fusing roller apparatus has a structure where the heat pipes are arranged to be localized, the fusing roller apparatus has a defect in that there is a temperature deviation among portions between the heat pipes and portions contacting the heat pipes.

In a scheme where resistance heat generating coils are inserted into an inner portion of the heat pipe, there is a problem in that power supply portions of both ends of the resistance heating member may be electrically and thermally weak. In general, a screw engagement scheme is used to insert and fasten the cap to both ends of the heat pipe. In a case where a torque of the heat pipe is too strong, in the screw engagement scheme, threads of screws may be crushed, and the caps may not be fastened. In addition, due to a limitation to a height of the threads of screws, there is a limitation in obtaining a heat pipe having a small thickness.

### SUMMARY OF THE INVENTION

The present invention provides a fusing unit having a locking assembly capable of preventing end caps at opposite ends of a heat pipe from separating from the heat pipe. The invention is also directed to a fusing apparatus using the fusing unit and a image forming apparatus having the fusing apparatus.

According to an aspect of the present invention, there is provided a fusing unit comprising: a pipe-shaped fusing roller provided with a pipe-shaped internal pipe surrounded by a heating unit generating heat; an end cap disposed at each end of the fusing roller; and a locking device for fastening the end caps to each respective end of the fusing roller, wherein the locking device has a first locking member fastened on an inner side surface of each respective fusing roller and a second locking member for fastening to one end of the fusing roller.

These and other aspects of the invention will become apparent from the following detailed description of the invention which disclose various embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a transverse cross sectional view schematically showing a fusing unit of a conventional fusing apparatus where a halogen lamp is used as a heat source;

FIG. 2 is a longitudinal cross sectional view showing a relation between a pressing roller and the fusing unit shown in FIG. 1;

FIG. 3 is a transverse cross sectional view showing a fusing apparatus of an image forming apparatus of the invention;

FIG. 4 is a longitudinal cross sectional view showing a fusing apparatus of an image forming apparatus of the invention;

FIG. 5 is a perspective view showing the locking device according to the present invention;

FIGS. 6A to 6D are views showing a first locking member shown in FIG. 5;

FIG. 7 is a partial side cross sectional view showing the end cap is fastened to a fusing roller by the first locking member according to the present invention; and

FIG. 8 is a side cross sectional view showing a state where an end cap is fastened to the fusing roller by the second locking member according to the present invention.

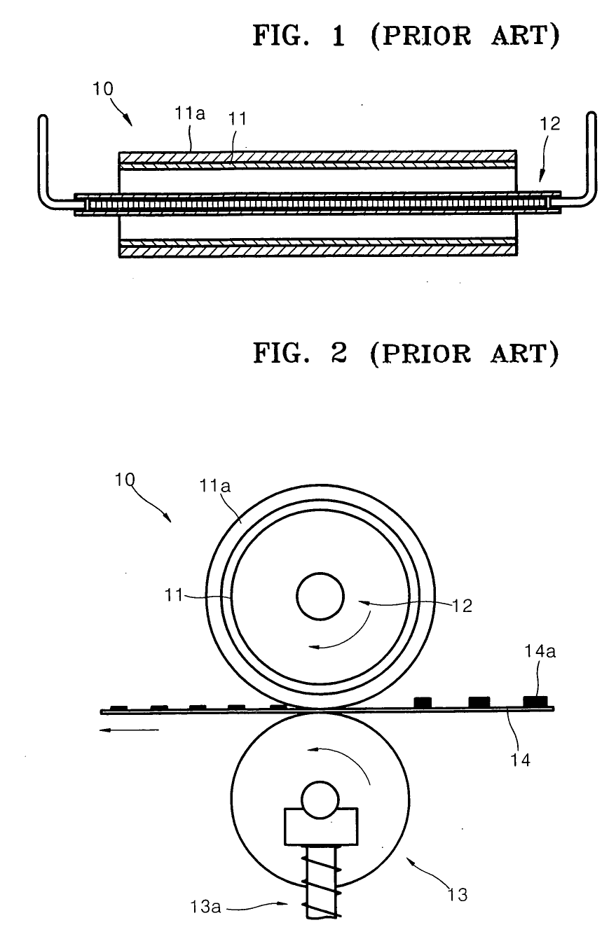

### DETAILED DESCRIPTION OF THE INVENTION

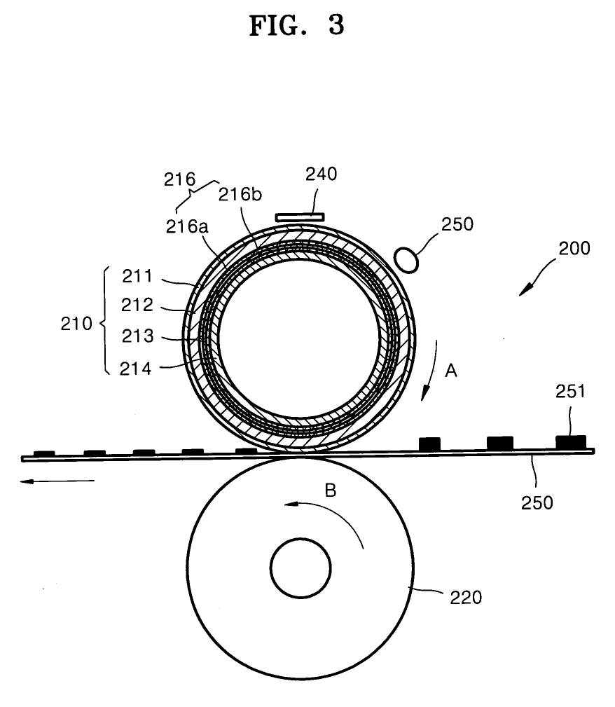

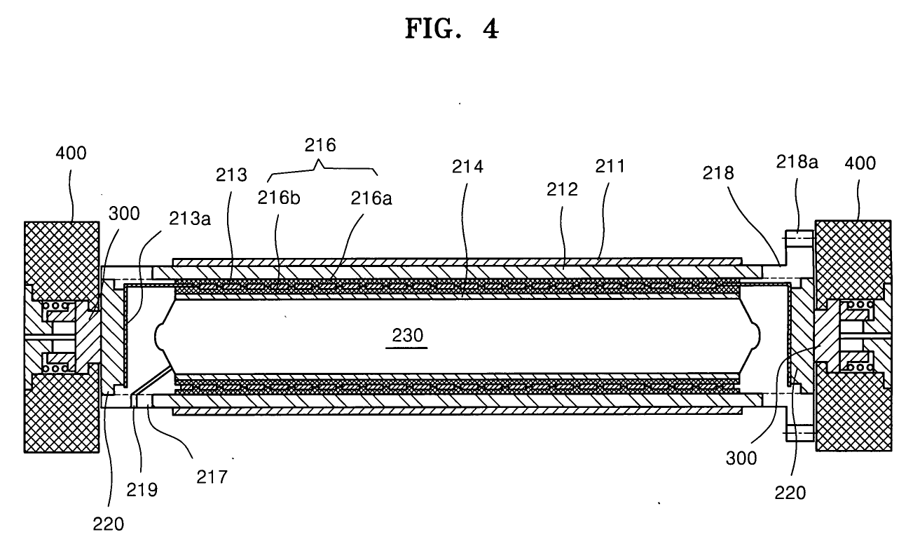

Referring to FIGS. 3 and 4, a fusing apparatus 200 is an apparatus for fusing a toner image 251 on a print medium 250 by applying heat and pressure to the toner image 251 and includes a fusing unit 210 applying heat to the toner image 251 while rotating in a direction of arrow A and a pressing roller 220 facing the fusing unit 210 rotating in the direction of arrow B. The print medium 250 is passed-between the fusing unit 210 and the roller 220 to press the toner image 251 toward the fusing unit 210.

The fusing unit 210 includes a pipe-shaped fusing roller 212 having a release layer 211 formed as a surface coating of Teflon™ or the like. An open-ended pipe-shaped internal pipe 214 is inserted into an inner portion of the fusing roller 212. A heating unit 213 is disposed between the fusing roller 212 and the internal pipe 214 and surrounding a circumferential surface of the internal pipe 214 in a spiral shape to generate heat with current supplied from an external power supply (not shown). An electrical insulating portion 216 surrounds the heating unit 213 to insulate the internal pipe 214 from the fusing roller 212 to prevent dielectric breakdown and leakage of current when the current is supplied to the heating unit 213.

The heating unit 213 is preferably constructed with resistance heat generating coils for generating heat by current supplied from the external power supply (not shown). Lead portions 213a extend from the heating unit 213 to receive current from the external power supply at both ends of the heating unit 213.

The electrical insulating portion 216 includes a first electrical insulating portion 216a disposed between the fusing roller 212 and the heating unit 213 and a second electrical insulating portion 216b disposed between the heating unit 213 and the internal pipe 214.

The electrical insulating portion 216 must not only transmit heat generated by the heating unit 213 but also have a suitable withstand voltage. The electrical circulating portion 216 must also be resistant to dielectric breakdown. The withstand voltage characteristic denotes a characteristic of withstanding an applied predetermined external electric power. The characteristic of resistance to dielectric breakdown denotes a characteristic of not generating a leakage current of 10 mA or more without dielectric breakdown for one minute under a maximum withstand voltage of 3 kV. The withstand voltage characteristic must be a standard that each insulating portion overcomes the applied withstand voltage of 3 kV in order to satisfy Canadian withstand voltage specifications defined by CSA (Canadian Standards Association) and European withstand voltage specifications.

An end cap 217 and a power transmission end cap 218 are disposed at opposite ends of the fusing roller 210, respectively. A construction of the power transmission end cap 218 is similar to that of the end cap 217, but the power transmission end cap 218 is provided with power transmission member 218a such as gears which are connected to a motor unit (not shown) mounted on a frame 400 supporting the fusing roller 210 to rotate the fusing roller 210.

An air vent 219 is formed on the end cap 217. The air vent 219 allows external air to flow into an internal space 230 of the fusing roller 210 after the end cap 217 is installed in the fusing roller 210, so that the internal space 230 of the fusing roller 210 can be maintained at the atmospheric pressure. Therefore, although the internal pipe 21 is heated with heat transmitted from the heating unit 213, the internal space 230 can be maintained at the atmospheric pressure due to the external air flowing through the air vent 219. The air vent 219 may be provided in the power transmission end cap 218.

Alternatively, the air vent 219 may be provided on both of the end cap 217 and the power transmission end cap 218.

Electrodes 220 are provided on the end cap 217 and power transmission end cap 218. The electrodes 220 are electrically connected to the lead portions 213a. Current supplied by the external power supply is applied to the heating unit 213 through the power supply unit 300, the electrodes 220, and the lead portions 213a.

Over the fusing unit 210, a thermostat 240 is provided for blocking power supply to prevent overheating in case the surface temperature of the release layer 211 rapidly increases and a thermistor 250 for measuring the surface temperatures of the fusing roller and the release layer 211.

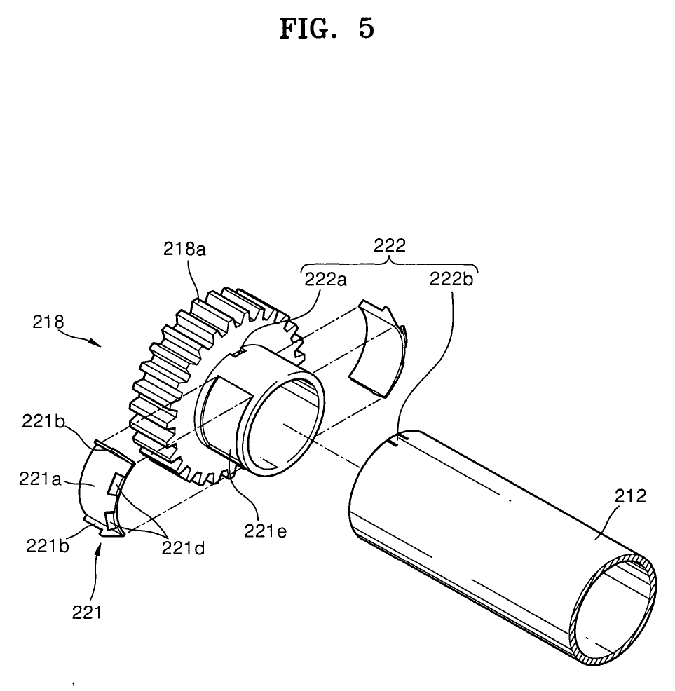

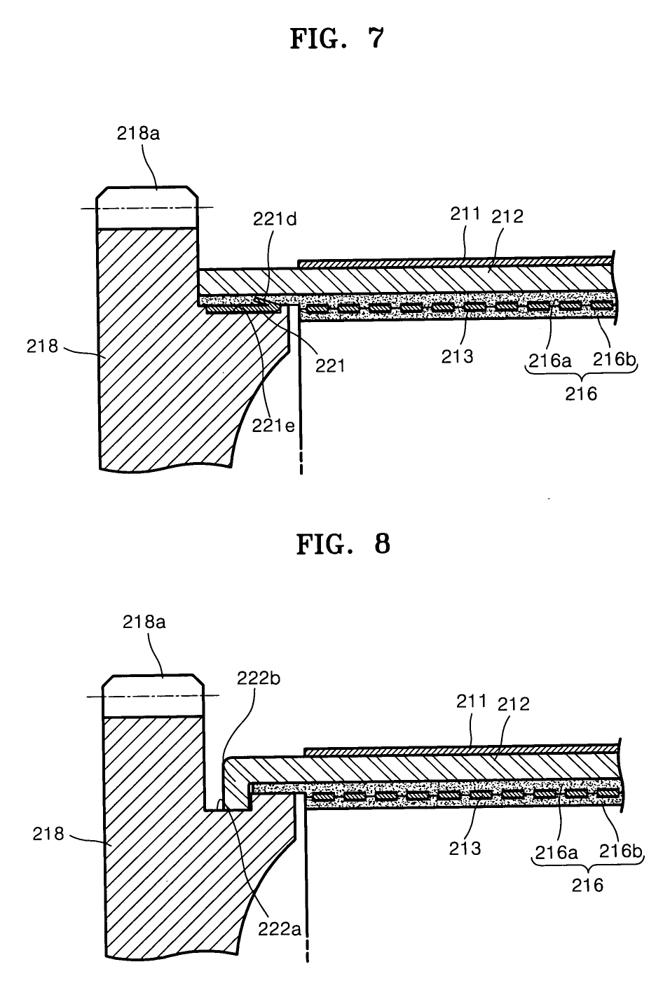

Referring to FIGS. 5 to 7, the image forming apparatus includes a locking assembly or means for fastening the end cap 217 and power transmission end cap 218 to the fusing roller 212. The locking assembly includes a first locking member 221 and a second locking member 222 which are on the end cap 217 and the power transmission end cap 218, respectively.

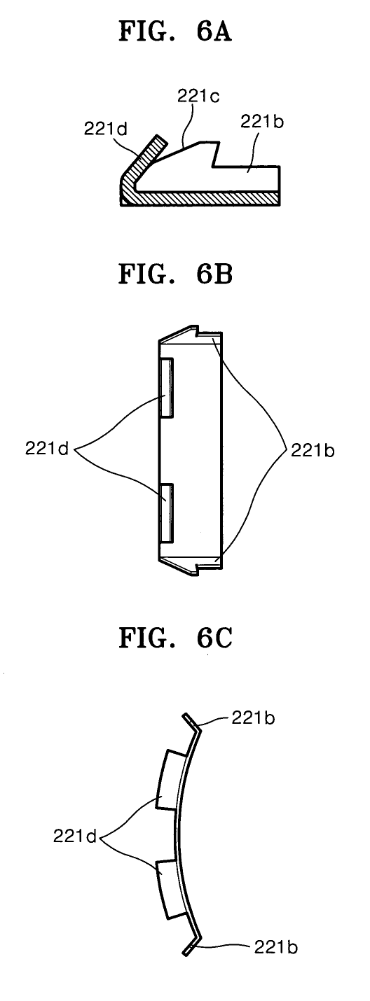

The first locking member 221 for fastening the end cap 217 and the power transmission end cap 218 to an inner side of the fusing roller 212 includes a base 221a curved in the shape of arch and has a predetermined curvature to exert an elastic force. The base 221a has first hooking portions 221b with hooking protrusions 221c protruding from both sides of the base 221a as shown in FIGS. 6A-6C to hook to the inner side surface of the fusing roller 212. A plurality of second hooking portions 221d protrude from an axial side of the base 221a to add areas to hook to the inner side surface of the fusing roller 212.

When the end cap 217 or the power transmission end cap 218 is mounted on the fusing roller 212, the second hooking portion 221d collides with the fusing roller 212 to be bent and hooked to the inner side surface of the fusing roller 212.

The inner side surface of the fusing roller 212 is made of a soft insulating material, so that the first and second hooking portions 221b and 221d can be hooked to the soft insulating material. It is preferable that the first and second hooking portions 221b and 221d be formed as integrated members of the base 221a.

The end cap 217 and the power transmission end cap 218 are provided with mounting grooves 221e on which the first locking members 221 are mounted. Therefore, although the first locking member 221 is mounted on the mounting groove 221e, the first and second hooking portions 221b and 221d protrude, so that the first and second hooking portions 221b and 221d can be hooked and fastened to the inner side surface of the fusing roller 212 while the end cap 217 and the power transmission end cap 218 are mounted on the fusing roller 212.

As shown in FIG. 8, the second locking member 222 includes a locking groove 222a formed on the end cap 217 and the power transmission end cap 218. Free ends 222b formed at both ends of the fusing roller 212 by cutting the fusing roller 212 by a predetermined length are received in the respective groove 222a. After the end cap 217 and the power transmission end cap 218 are mounted on the fusing roller 212, the end cap 217 and the power transmission end cap 218 are fastened to the fusing roller 212 by bending and inserting the free end 222b to the locking groove 222a.

The plurality of the first locking members 221 are symmetrically disposed at the end cap 217 and the power transmission end cap 218, and the plurality of the second locking members 222 are disposed between the plurality of the first locking members 221.

The shapes of the first and second hooking portions 221b and 221d is not limited to the shapes according to the present invention, but various modified shapes, if having the same function, can be used.

In a fusing unit according to the present invention and an image forming apparatus using the fusing unit, an end cap and a power transmission end cap can be securely fastened to a fusing roller to prevent the fusing roller from sliding in a shaft direction or running idle in a arch direction, so that it is possible to ensure a stable engagement force.

While various embodiments have been chosen to illustrate the invention, modifications can be made without departing from the scope of the invention as recited in the appended claims.

What is claimed is:

1. A fusing unit comprising:
a pipe-shaped fusing roller having with a pipe-shaped internal pipe surrounded by a heating unit for generating heat;
an end cap disposed at opposite ends of the fusing roller; and
locking assembly for fastening the end cap to each respective end of the fusing roller, wherein the locking assembly has a first locking member fastened to an inner side surface of the fusing roller and a second locking member fastening on one end of the fusing roller.

2. The fusing unit according to claim 1,
wherein the first locking member is mounted in a mounting groove formed in the end cap, and
wherein the first locking member has a first hooking portion with a hooking protrusion to hook to the inner side surface of the fusing roller and a second hooking portion to hook to the inner side surface of the fusing roller.

3. The fusing unit according to claim 2, wherein the second hooking portion is bent portion to hook to the inner surface of the fusing roller when the end cap is mounted on the fusing roller.

4. The fusing unit according to claim 1, wherein the second locking member fastens the end cap to the fusing roller and where the second locking member is a locking groove on the end cap, and where the fusing roller has a bendable free end that is bent to couple to the locking groove.

5. The fusing unit of claim 1, wherein
each said end cap includes an outer annular surface having an outwardly facing groove, and where the first locking member is received in said groove.

6. The fusing unit of claim 5, wherein
said first locking member has an arcuate shape and has an outer surface facing radially outward with respect to said end cap;
said first locking member having a first hooking portion extending in an axial direction with respect to said end cap; and
a second hooking portion extending in an arcuate direction with respect to said end cap, said first and second hooking portions being oriented to engage an inner surface of said fusing roller.

7. A fusing apparatus having a fusing unit for generating heat and a pressing roller for pressing a print medium passing through a contact portion between the fusing unit and the pressing roller,
wherein the fusing unit comprises:
a pipe-shaped fusing roller having a pipe-shaped internal pipe surrounded by a heating unit for generating heat;
an end cap disposed at opposite ends of the fusing roller; and
locking assembly for fastening the plurality of end caps to each respective end of the fusing roller, and
wherein the locking assembly has a first locking member fastened to an inner side surface of the fusing roller and a second locking member fastening on one end of the fusing roller.

8. The fusing apparatus according to claim 7,
wherein the first locking member is mounted in a mounting groove formed in the end cap, and
wherein the first locking member has a first hooking portion provided with a hooking protrusion to hook to the inner side surface of the fusing roller and a second hooking portion to hook to the inner side surface of the fusing roller.

9. The fusing apparatus according to claim 8, wherein the second hooking portion is a bent portion to hook to the inner surface of the fusing roller when the end cap is mounted on the fusing roller.

10. The fusing apparatus according to claim 7, wherein the second locking member fastens the end cap to the fusing roller and where the second locking member is a locking groove on the end cap, and where the fusing roller has a bendable free end that is bent to couple to the locking groove.

11. An image forming apparatus having a fusing apparatus having a fusing unit for generating heat and a pressing roller for pressing a print medium passing through a contact portion between the fusing unit and pressing roller.
Wherein the fusing unit comprises:
a pipe-shaped fusing roller having a pipe-shaped internal pipe surrounded by a heating unit for generating heat;
an end cap disposed at opposite ends of the fusing roller; and
locking assembly for fastening the plurality of end caps to each respective end of the fusing roller, and
wherein the locking assembly has a first locking member fastened to an inner side surface of the fusing roller and a second locking member fastening on one end of the fusing roller.

12. The image forming apparatus according to claim 11,
wherein the first locking member is mounted in a mounting groove formed in the end cap, and
wherein the first locking member has a first hooking portion provided with a hooking protrusion to hook to the inner side surface of the fusing roller and a second hooking portion to hook to the inner side surface of the fusing roller.

13. The fusing apparatus according to claim 12, wherein the second hooking portion is a bent portion to hook to the inner surface of the fusing roller when the end cap is mounted on the fusing roller.

14. The fusing apparatus according to claim 11, wherein the second locking member fastens the end cap to the fusing roller and where the second locking member is a locking groove on the end cap, and where the fusing roller has a bendable free end that is bent to couple to the locking groove.
